(19) United States
(12) Patent Application Publication
(10) Pub. No.: US 2016/0132896 A1
(43) Pub. Date: May 12, 2016

(54) Global Regulatory Compliance Optimization Tool

(71) Applicant: INTERNATIONAL BUSINESS MACHINES CORPORATION, Armonk, NY (US)

(72) Inventors: Barbara R. Guerin, Reno, NV (US); Russell J. Miller, Pittsburgh, PA (US); Dennis G. Tougas, Atlanta, GA (US); Gary D. Wexler, Redding, CT (US)

(21) Appl. No.: 14/539,497

(22) Filed: Nov. 12, 2014

(51) Int. Cl. G06Q 30/00

(52) U.S. Cl. CPC G06Q 30/018

(57) ABSTRACT

A method, computer program product, and/or hardware system optimizes regulatory compliance. An industry category for an enterprise is identified. A set of regulatory requirements for the industry category is stored in a database. The set of regulations are categorized by focus areas, summary requirements, and harmonized detailed requirements, wherein the focus areas describe components of regulatory requirements, wherein the summary requirements summarize each first tier subcomponent of the components of the regulatory requirements, and wherein the harmonized detailed requirements describe second tier subcomponents of each first tier component. Detailed requirements for each set of regulations are mapped to one or more of the focus areas, summary requirements, and harmonized detailed requirements. The detailed requirements are mapped to compliance resources. The compliance resources are executed to satisfy the detailed requirements.

### BACKGROUND

The present disclosure relates to the field of regulations, and specifically to the field of regulatory compliance. Still more specifically, the present disclosure relates to the field of optimizing regulatory compliance across multiple boundaries.

Regulatory compliance is a term used to describe enterprises' efforts to ensure that they are in accord with laws, regulations, and other standards for their industry type.

### SUMMARY

A method, computer program product, and/or hardware system optimizes regulatory compliance. An industry category for an enterprise is identified. A set of regulatory requirements for the industry category is stored in a database. The set of regulations is categorized by focus areas, summary requirements, and harmonized detailed requirements, wherein the focus areas describe components of regulatory requirements, wherein the summary requirements summarize each first tier subcomponent of the components of the regulatory requirements, and wherein the harmonized detailed requirements describe second tier subcomponents of each first tier component. Detailed requirements for each set of regulations are mapped to one or more of the focus areas, summary requirements, and harmonized detailed requirements. The detailed requirements are mapped to compliance resources. The compliance resources are executed to satisfy the detailed requirements.

### BRIEF DESCRIPTION OF THE SEVERAL VIEWS OF THE DRAWINGS

FIG. 1 depicts a cloud computing node according to an embodiment of the present invention;

FIG. 2 illustrates a cloud computing environment according to an embodiment of the present invention;

FIG. 3 depicts abstraction model layers according to an embodiment of the present invention;

FIG. 4 is a high level flow-chart of one or more operations performed by one or more processors or other hardware devices to optimize regulatory compliance; and

FIG. 5 illustrates an exemplary system in which the present invention may be utilized.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, it is to be understood that in one or more embodiments, the present invention is capable of being implemented in a cloud computing environment.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

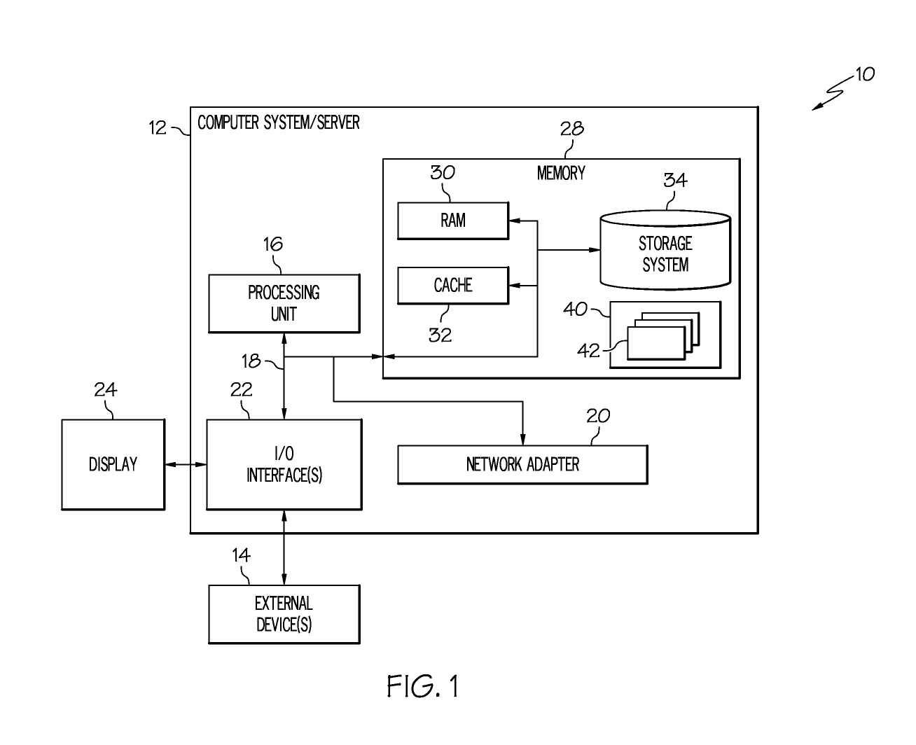

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

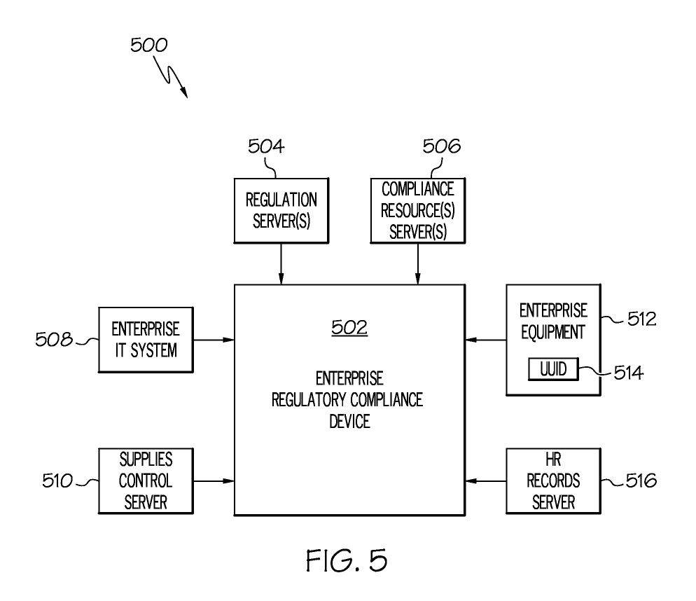

In one or more embodiments of the present invention, external devices 14 utilize the architecture of the computer system/server 12 shown in FIG. 1. Similarly, the architecture of computer system/server 10 can be implemented in the enterprise regulatory compliance device 502, regulation server(s) 504, compliance resource(s) server(s) 506, enterprise information technology system 508, supplies control server 510, and/or human resources records server 516 shown in FIG. 5.

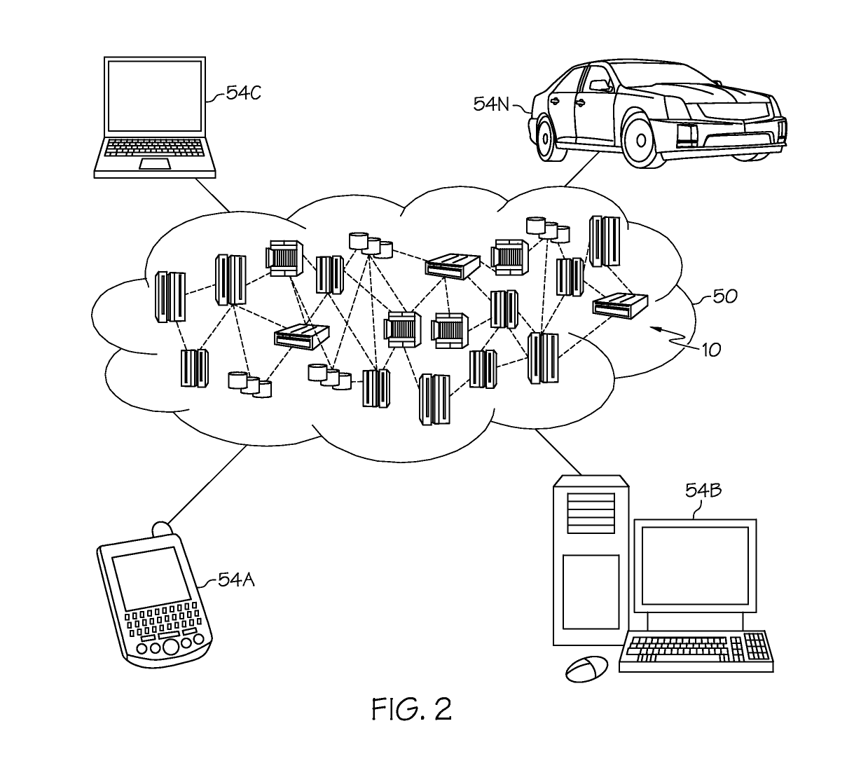

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone MA, desktop computer MB, laptop computer 54C, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Thus present invention presents a Global Regulatory Optimization Tool (GROT), which captures, analyzes, and manages industry and government regulatory requirements relevant to the delivery of managed services for complying with such regulations. Various search, query, and reporting capabilities are available in the GROT, including access to checklists that are specific for certain subject matter experts, focus areas, summary requirements, harmonized detailed requirements, and detailed requirements (all discussed below).

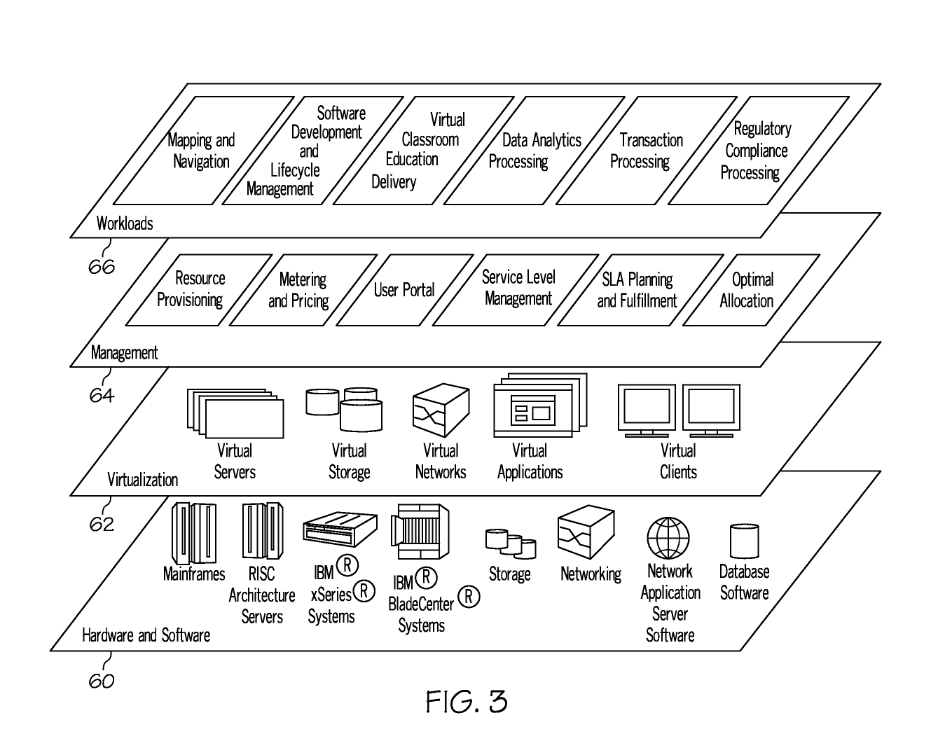

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and regulatory compliance, as described herein, and as represented by the “Regulatory Compliance Processing” found in workloads layer 66.

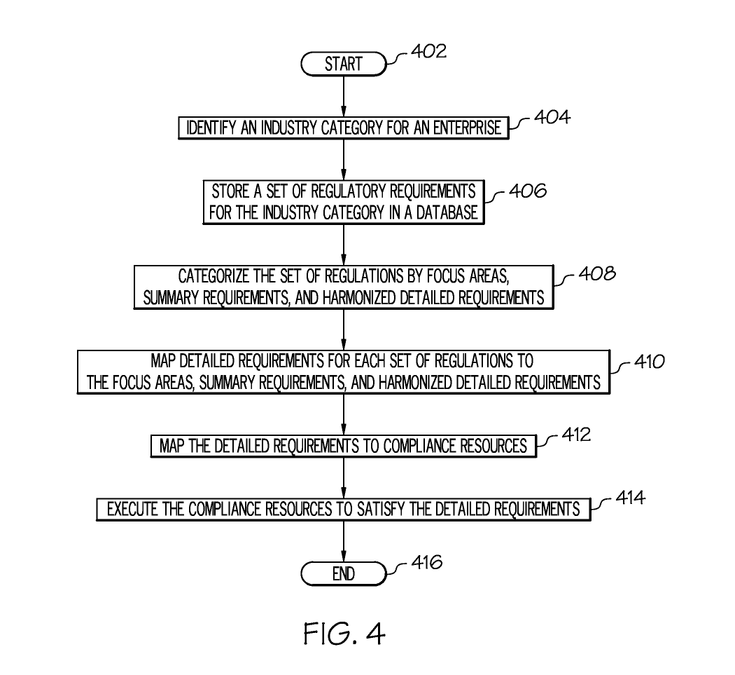

With reference now to FIG. 4, a high level flow chart of one or more steps performed by one or more processors and/or other hardware devices for optimizing regulatory compliance is presented. After initiator block 402, one or more processors identifies an industry category for an enterprise (block 404). That is, an enterprise is identified as being part of one or more categories, such as construction, manufacturing, health care, etc. While this industry category identification can be made manually by a subject matter expert in the field of industry categorization, in other embodiments the industry category identification is made (or augmented) by technology-dependent activities.

For example, in an embodiment of the present invention, a processor receives coded information that identifies what types of information technology resources are in use by the enterprise, and the industry category for the enterprise is identified based on what types of information technology resources are in use by the enterprise. For example, consider the system 500 depicted in FIG. 5. An enterprise regulatory compliance device 502 (e.g., a computer system that is allocated to overseeing regulatory compliance measures taken by one or more enterprises) is communicatively coupled to an enterprise information technology (IT) system 508. The type of hardware/software used by enterprise IT system 508 can be used to identify the industry category for the enterprise that is using the enterprise IT system 508. In an embodiment, the coded information (e.g., the description of the IT resources) is sent directly from the IT resources to a computer in a format that is only interpretable by a processor, such that no human intervention is utilized.

For example, assume that the enterprise IT system 508 is a system that supports a supervisory control and data acquisition (SCADA) system (or a similar type of system) that provides control over remote equipment. Assume further that an examination of the SCADA system reveals that the remote equipment being controlled by the SCADA system includes pumps, sensors, heaters, etc. that are typically found in a petrochemical refinery. This knowledge allows the enterprise regulatory compliance device 502 to conclude that this enterprise is engaged in petrochemical refinery operations, and thus comes under the purview of certain regulations (e.g., 29 CFR 1910.119 of the United States Occupational Safety and Health Administration (OSHA) regulations related to worker safety in chemical plants, environmental regulations for chemical plants promulgated by the United States Environmental Protection Agency, etc.)

Similarly, if the enterprise IT system 508 is a system that supports highly classified encryption protocols (e.g., military grade), then the enterprise regulatory compliance device 502 will conclude that this enterprise is involved in security and/or intelligence activities, which come under the regulations of the U.S. Department of Defense, Homeland Security, etc.

In an embodiment of the present invention, a processor receives coded information that identifies supplies that are used by the enterprise, and identifies the industry category for the enterprise based on the supplies that are used by the enterprise. For example, assume that the supplies control server 510 in FIG. 5 contains records indicating that an enterprise has ordered 500 bottles of aspirin, even though the enterprise manufactures automobiles. The presence of 500 bottles of aspirin would indicate that the enterprise has an on-site medical provider (e.g., a company physician/nurse). The enterprise would assume that it comes under regulations covering automobile manufacturers (e.g., OSHA, EPA, etc.), but might overlook regulations that apply to health care providers (e.g., the United States Health Information Portability and Accountability Act (HIPAA)). Thus, by detecting the large quantity of medications (as recorded by the supplies control server 510), the enterprise regulatory compliance device 502 will determine that the enterprise comes under HIPAA. In one embodiment, the coded information is sent directly to a processor in a format that is only computer-readable, thus bypassing any human interaction.

In an embodiment of the present invention, a processor receives coded information that identifies job descriptions of employees of the enterprise, and identifies the industry category for the enterprise based on the job descriptions of employees of the enterprise. For example, assume that the human resource (HR) records server 516 in FIG. 5 shows an employment record for a health care worker. Again, assume further that the enterprise is a chemical plant. The presence of an employee record for a health care worker (e.g., a nurse, physician, physician's assistant, etc.) would indicate that the enterprise has an on-site medical provider (e.g., a company physician/nurse). The enterprise would assume that it comes under regulations covering chemical plants (e.g., OSHA, EPA, etc.), but might overlook regulations that apply to health care providers (e.g., the United States Health Information Portability and Accountability Act (HIPAA)). Thus, by detecting the employment record of a health care provider (as recorded by the HR records server 516 in FIG. 5), the enterprise regulatory compliance device 502 will determine that the enterprise comes under HIPAA.

In an embodiment of the present invention, a processor receives coded information that identifies a type of equipment that is in use by the enterprise, and identifies the industry category for the enterprise based on the type of equipment that is in use by the enterprise. For example, assume that an enterprise uses enterprise equipment 512, as depicted in FIG. 5, in its operations. Assume further that one or more units of the enterprise equipment 512 is tagged with an identifier (e.g., a universally unique identifier—UUID 514), which identifies the type of equipment, the model number, the manufacturer, etc. UUID 514 is a data storage device that contains data describing the enterprise equipment 512, particularly equipment to which the UUID 514 is attached and/or otherwise associated with. Information found in the UUID 514 can be interpreted by the enterprise regulatory compliance device 502 to determine what industry category/categories apply to this enterprise. For example, if the UUID 514 identifies certain equipment as being blast furnaces, then the enterprise regulatory compliance device 502, based on data received from the UUID 514, will conclude that this enterprise has foundry operations, and thus comes under the purview of regulations promulgated by OSHA and/or the EPA. If the UUID 514 contains data for enterprise equipment 512 indicating that the enterprise equipment is advanced medical equipment (e.g., a medical X-Ray machine), then the enterprise regulatory compliance device 502 will (further) determine that the enterprise has health care operations, and thus comes under HIPAA. In an embodiment, the coded information (e.g., the UUID information) is sent directly to a computer in a format that is only interpretable by a processor, such that no human intervention is utilized.

While determining that an enterprise is a particular type of industry based on information from the enterprise IT system 508, supplies control server 510, HR records server 516, and/or UUIDs 514 as described above, in an embodiment this information is used only as a starting point in determining the industry type. That is, in an embodiment, such information may be used to statistically determine what industry type applies to a particular enterprise.

For example, in the scenario in which UUID 514 information is used, consider the following exemplary Bayesian probability formula:

$$P ( A \vert B ) = \frac{P ( B \vert A ) P ( A )}{P ( B )}$$

where:
P(A|B) is the probability that an enterprise is (at least partially) a health care provider that comes under HIPAA (A) given that (|) the UUID 514 identifies a medical X-Ray machine on the premises (B);
P(B|A) is the probability that the enterprise will have a medical X-Ray machine (B) given that (|) the enterprise provides health care services (A);
P(A) is the probability that the enterprise provides health care regardless of any other information; and
P(B) is the probability that the enterprise will have a medical X-Ray machine regardless of any other information.

For example, assume that 8% of all enterprises have medical X-Ray machines on their premises, thus making P(B)=0.08. Assume further that 5% of all enterprises provide health care services, thus placing P(A) at 0.05. Furthermore, historical data shows that the probability that an enterprise has a medical X-Ray machine (B) given that (I) the enterprise is a health care provider (A) is 95% (i.e., P(B|A)=0.95). Based on these probabilities, then the probability P(A|B) that any enterprise having a medical X-Ray machine on the premises is a provider of health care (at least to its employees) is 59%:

$$P ( A \vert B ) = \frac{.95 * .05}{.08} = .59$$

If 59% exceeds some predetermined value (e.g., 50%), then the enterprise regulatory compliance device 502 will conclude that this enterprise provides health care services, and thus comes under HIPAA.

Returning to FIG. 4, one or more processors store a set of regulatory requirements for the industry category in a database (e.g., within database(s) supported by regulation server(s) 504 shown in FIG. 5), as described in block 406. These regulatory requirements are not only for a particular industry category (e.g., manufacturing, construction, health care, etc.), but may also be for a particular geopolitical region (e.g., a particular city/county/state, a particular country, the European Union, etc.).

As described in block 408, one or more processors categorizes the set of regulations by focus areas, summary requirements, and harmonized detailed requirements.

The focus areas describe components of regulatory requirements. Examples of such components of regulatory requirements include, but are not limited to, access control (e.g., what administrative, physical or technical security features protect information operations of an institution from unauthorized access, modification, or disclosure); asset management (e.g., identifying, tracking, classifying and assigning ownership for the most important assets adequately protected, such that an overall asset management strategy is in place to protect assets and information technology equipment); business continuity and disaster recovery (e.g., identification of vulnerabilities, priorities, dependencies, and measures for developing programs for recovery before, during, and after a disruption); communication security (e.g., preventing unauthorized intercepts from accessing telecommunication and delivering content to the intended recipients); compliance (e.g., meeting the requirements of established policies, guidelines, specifications, and/or legislation); cryptography (e.g., protecting information by transforming (e.g., encrypting) it into an unreadable format without proper decryption code); data privacy (e.g., the rights and obligations of individuals and organizations with respect to the collection and disposal of personal information); export/import (e.g., compliance with regulations that control the export and import of certain articles and services); human resource controls (e.g., controls that ensure that all employees are cognizant of their roles and responsibility according to the job duties); incident management (e.g., detecting, reporting, and responding to adverse events as well as weaknesses which need to be addressed); management policies (e.g., providing management direction and support in accordance with business requirements and relevant laws and regulations); operations security (e.g., identification of critical information and the execution of selected measures that protect such critical information); organization structures (e.g., the establishment of a management framework to initiate and control the implementation and operation of internal controls within the organization); physical and environmental security (e.g., measures taken to protect systems, buildings, and related supporting infrastructure); quality management (e.g., tools and resources to help improve the quality of the product/service being provided by the enterprise); records management (e.g., systems and processes for the collection, organization, and categorization of records for their retrieval, use, and disposition); risk management (e.g., the identification, assessment, and prioritization of risks followed by coordinated and economical application of remedial steps taken thereon); and system acquisition development and maintenance (e.g., the identification and incorporation of controls into the processor for acquiring, developing, and deploying information system technologies).

The summary requirements summarize each first tier subcomponent of the components of the regulatory requirements. For example, summary requirements for the organization structures described above may include information about internal organization (e.g., information security roles and responsibilities governing the operation of information security within the organization); external organization (e.g., describing the appropriate contact with authorities, specialist security forums, and provisional associations to be maintained); and information security in project management (e., information security that is to be addressed in project management, regardless of the type of the project).

Harmonized detailed requirements describe second tier subcomponents of each first tier component. For example, assume that a summary requirement (first tier subcomponent) of the human resources controls described above describes controls to be taken prior to employment, during employment, termination of employment, and education and training The second tier subcomponents of the first tier “prior to employment” subcomponent may be to 1) perform background checks; 2) match job applicants to appropriate jobs according to their qualifications; 3) ensure that proper contractual language is used with contractors and subcontractors; etc. Thus, the Harmonized Detail Requirements (HDRs) in the GROT represent the commonalities among the many global regulatory requirements in language that captures the essence of the collective body of detailed requirements. In one embodiment of the present invention, these requirements are harvested on a periodic basis from the Detailed Requirements (described herein) that are input to the GROT by subject matter experts.

Returning again to FIG. 4, one or more processors map detailed requirements for each set of regulations to one or more of the focus areas, summary requirements, and harmonized detailed requirements, as described in block 410. For example, a detailed requirement of a regulation may be to provide health care workers with training in blood borne diseases. This requirement is matched to the focus area “human resources controls”, the summary requirement “provide employee training”, and the harmonized detailed requirement “provide training to phlebotomists”. Furthermore, this same requirement may also be matched to the focus area “records management”, the summary requirement “record employee training”, and the harmonized detailed requirement “record employee training related to blood borne diseases”.

As described in block 412, one or more processors map the detailed requirements to compliance resources, which may be stored and/or accessible from the compliance resource(s) server(s) 506 shown in FIG. 5. For example, if the detailed requirement is to provide health care workers with training in blood borne diseases, then this detailed requirement may be mapped to a particular training syllabus, which is available within the enterprise or from a third party having access to compliance resource(s) server(s) 506.

As described in block 414, the located compliance resources are executed, thus satisfying the detailed requirements. The flow-chart ends at terminator block 416.

In an embodiment of the present invention, one or more processors identify any gaps between the detailed requirements and abilities of the compliance resources to satisfy the detailed requirements, thus allowing the compliance resources to be modified in order to eliminate the gaps. For example, assume that a detailed requirement requires that training on blood borne diseases includes the use of training mannequins that simulate a bleeding person. Assume further that the enterprise has access to a training syllabus, but not the mannequins. The mannequins thus cause the gap between what is needed by the detailed requirements and the available compliance resources, and are acquired in order to eliminate this gap.

In an embodiment of the present invention, one or more processors identify any overlapping requirements in the set of regulatory requirements for the industry category, and generate a consolidated regulatory requirement that contains all requirements of the set of regulatory requirement with only a single instance of any overlapping requirement. For example, assume that a first regulation requires elements A, B, and C. Assume further that a second regulation requires elements A, B, and D. The consolidated regulatory requirement would thus contain the elements A, B, C, and D (rather than two separate requirements to satisfy A, B, C, and then A, B, D). For example, assume that a first country requires that medical records be maintained (stored) by a health care provider for at least 5 years, and a second country requires that the medical records be maintained for at least 7 years. Rather than having two different policies for an enterprise operating in both countries, the consolidated regulatory requirement would be to maintain all records for at least 7 years, since 5 years is a component of 7 years.

Note that the different regulations may be from different cities, counties, etc. within a state, different states within a country, etc.

In an embodiment of the present invention, the overlapping requirements are caused by overlapping requirements from regulations in different governmental entities. For example, OSHA may require certain employee training records to be maintained for at least 3 years, while the EPA may require these employee training records to be maintained for at least 5 years. The consolidated regulatory requirement would direct these employee training records to be maintained for at least 5 years.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method for optimizing regulatory compliance, the method comprising:
identifying, by one or more processors, an industry category for an enterprise;
storing, by one or more processors, a set of regulatory requirements for the industry category in a database;
categorizing, by one or more processors, the set of regulations by focus areas, summary requirements, and harmonized detailed requirements, wherein the focus areas describe components of regulatory requirements, wherein the summary requirements summarize each first tier subcomponent of the components of the regulatory requirements, and wherein the harmonized detailed requirements describe second tier subcomponents of each first tier component;
mapping, by one or more processors, detailed requirements for each set of regulations to one or more of the focus areas, summary requirements, and harmonized detailed requirements;
mapping, by one or more processors, the detailed requirements to compliance resources; and
executing the compliance resources to satisfy the detailed requirements.

2. The method of claim 1, further comprising:
identifying, by one or more processors, any gaps between the detailed requirements and abilities of the compliance resources to satisfy the detailed requirements; and
modifying the compliance resources to eliminate the gaps.

3. The method of claim 1, further comprising:
identifying, by one or more processors, any overlapping requirements in the set of regulatory requirements for the industry category; and
generating, by one or more processors, a consolidated regulatory requirement that contains all requirements of the set of regulatory requirement with only a single instance of any overlapping requirement.

4. The method of claim 3, wherein overlapping requirements are caused by overlapping requirements from regulations in different governmental entities.

5. The method of claim 4, wherein the different governmental entities are different geopolitical entities.

6. The method of claim 1, further comprising:
receiving, by a processor, coded information that identifies what types of information technology resources are in use by the enterprise, wherein the coded information is transmitted to the processor directly from information technology resources that are in use by the enterprise; and
identifying the industry category for the enterprise based on what types of information technology resources are in use by the enterprise.

7. The method of claim 1, further comprising:
receiving, by a processor, coded information that identifies supplies that are used by the enterprise, wherein the coded information is transmitted in computer-readable format directly to the processor; and
identifying the industry category for the enterprise based on the supplies that are used by the enterprise.

8. The method of claim 1, further comprising:
receiving, by a processor, coded information that identifies a type of equipment that is in use by the enterprise, wherein the coded information is transmitted to the processor directly from equipment that is in use by the enterprise; and
identifying the industry category for the enterprise based on the type of equipment that is in use by the enterprise.

9. The method of claim 1, further comprising:
receiving, by a processor, coded information that identifies job descriptions of employees of the enterprise, wherein the code information is in a computer-readable format that is interpretable only by the processor; and
identifying the industry category for the enterprise based on the job descriptions of employees of the enterprise.

10. The method of claim 1, further comprising:
identifying the industry category for the enterprise according to the probability formula:
$$P ( A \vert B ) = \frac{P ( B \vert A ) P ( A )}{P ( B )}$$
where:
P(A|B) is a probability that an enterprise is in a particular industry category (A) given that (|) the certain conditions exist within the enterprise (B);
P(B|A) is the probability that the certain conditions exist with the enterprise (B) given that (|) the enterprise is in the particular industry category (A);
P(A) is the probability that the enterprise is in the particular industry category regardless of any other information; and
P(B) is the probability that certain conditions will exist within the enterprise regardless of any other information.

11. A computer program product for optimizing regulatory compliance, the computer program product comprising a computer readable storage medium having program code embodied therewith, wherein the computer readable storage medium is not a transitory signal per se, and wherein the program code is readable and executable by a processor to perform a method comprising:
identifying an industry category for an enterprise;
storing a set of regulatory requirements for the industry category in a database;
categorizing the set of regulations by focus areas, summary requirements, and harmonized detailed requirements, wherein the focus areas describe components of regulatory requirements, wherein the summary requirements summarize each first tier subcomponent of the components of the regulatory requirements, and wherein the harmonized detailed requirements describe second tier subcomponents of each first tier component;
mapping detailed requirements for each set of regulations to one or more of the focus areas, summary requirements, and harmonized detailed requirements;
mapping the detailed requirements to compliance resources; and
executing the compliance resources to satisfy the detailed requirements.

12. The computer program product of claim 11, wherein the method further comprises:
identifying any gaps between the detailed requirements and abilities of the compliance resources to satisfy the detailed requirements; and
modifying the compliance resources to eliminate the gaps.

13. The computer program product of claim 11, wherein the method further comprises:
identifying any overlapping requirements in the set of regulatory requirements for the industry category; and
generating a consolidated regulatory requirement that contains all requirements of the set of regulatory requirements with only a single instance of any overlapping requirement.

14. The computer program product of claim 13, wherein overlapping requirements are caused by overlapping requirements from regulations in different governmental entities.

15. The computer program product of claim 14, wherein the different governmental entities are different geopolitical entities.

16. The computer program product of claim 11, wherein the method further comprises:
receiving, by a processor, coded information that identifies what types of information technology resources are in use by the enterprise; and
identifying the industry category for the enterprise based on what types of information technology resources are in use by the enterprise.

17. The computer program product of claim 11, wherein the method further comprises: receiving, by a processor, coded information that identifies supplies that are used by the enterprise; and
identifying the industry category for the enterprise based on the supplies that are used by the enterprise.

18. The computer program product of claim 11, wherein the method further comprises:
receiving, by a processor, coded information that identifies equipment that is in use by the enterprise; and
identifying the industry category for the enterprise based on the equipment that is in use by the enterprise.

19. The computer program product of claim 11, wherein the method further comprises:
receiving, by a processor, coded information that identifies job descriptions of employees of the enterprise; and
identifying the industry category for the enterprise based on the job descriptions of employees of the enterprise.

20. A hardware device comprising:
a hardware processor, a computer readable memory, and a computer readable storage medium;
first program instructions to identify an industry category for an enterprise;
second program instructions to store a set of regulatory requirements for the industry category in a database;
third program instructions to categorize the set of regulations by focus areas, summary requirements, and harmonized detailed requirements, wherein the focus areas describe components of regulatory requirements, wherein the summary requirements summarize each first tier subcomponent of the components of the regulatory requirements, and wherein the harmonized detailed requirements describe second tier subcomponents of each first tier component;
fourth program instructions to map detailed requirements for each set of regulations to one or more of the focus areas, summary requirements, and harmonized detailed requirements;
fifth program instructions to map the detailed requirements to compliance resources; and
sixth program instructions to execute the compliance resources to satisfy the detailed requirements; and wherein
the first, second, third, fourth, fifth, and sixth program instructions are stored on the computer readable storage medium and executed by the processor via the computer readable memory.
